(19) United States
(12) Patent Application Publication
(10) Pub. No.: US 2010/0231967 A1
(43) Pub. Date: Sep. 16, 2010

(54) INFORMATION PROCESSING APPARATUS

(75) Inventor: Yasuhiro Arai, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/721,455

(22) Filed: Mar. 10, 2010

(30) Foreign Application Priority Data
Mar. 11, 2009 (JP) 2009-058322

(51) Int. Cl. G06F 15/00

(52) U.S. Cl. 358/1.15

(57) ABSTRACT

Provided is an information processing apparatus which transmits a file of to-be-printed data to a printer to perform printing, including: a determining unit which determines whether or not a data size of the file exceeds the predetermined receivable size of the printer; a reduction condition determining unit which predicts and determines a reduction condition; a reduction processing unit which reduces the data size of the file based on the determined reduction condition; and a re-determining unit which performs determination of the reduction condition of the reduction condition determining unit and the processing of reducing the data size of the file by the reduction processing unit again.

### CROSS REFERENCES TO RELATED APPLICATIONS

The entire disclosure of Japanese Patent Application No. 2009-058322, filed Mar. 11, 2009 is expressly incorporated by reference herein.

### BACKGROUND

1. Technical Field

The present invention relates to a printer driver that is installed into a computer of an information processing apparatus that transmits a file of to-be-printed data such as image data to a printer to perform printing and the information processing apparatus, and more particularly, to reduction of a data size of a file in the case where the data size of to-be-printed data is larger than a receivable data size of a printer.

2. Related Art

In the related art, image data of a still image of a imaging apparatus such as a digital camera are image data of a JPEG (Joint Photographic Experts Group) file that is used as an Exif (Exchangeable image file format) compressed file.

In the case where a printer performs printing image data of the imaging apparatus, a direct print adaptor is, for example, disposed between the digital camera and the printer, and the image data of the JPEG file of the digital camera are converted into printing data (raster-format data) by the direct print adaptor, so that the printing data are transmitted to the printer to be printed (for example, refer to Paragraphs [0043], [0048], FIG. 1, and FIG. 2 of Japanese Patent 3,593,820)

In addition, recently, in an information processing apparatus having a computer configuration such as a high-performance home game machine, in the case where image data (to-be-printed data) of a JPEG file of the information processing apparatus obtained through capturing of a digital camera or downloading from a website or the like are printed by a printer, under the printing control of a predetermined command of a printer driver installed in the information processing apparatus, the JPEG file is transmitted from the information processing apparatus as a host apparatus to the printer as a device apparatus, and the image data of the received JPEG file are converted into printing data and the printing is performed by the printer.

As described above, in the case where the file of the to-be-printed data is transmitted from the information processing apparatus as a host apparatus to the printer as a device apparatus and the printing is performed by the printer, because of limitation of the printer resources (memory of receiving buffer) or limitation of the printing command, a file having a data size that exceeds a predetermined receivable size (for example, 5 MB or 3 MB: MB is megabyte) cannot be received by the printer.

In addition, in the case where the file of the to-be-printed data transmitted from the information processing apparatus to the printer is, for example, a JPEG file, a data size of the file of the image data of an image having a large capturing size or an image having a high image quality may exceed the predetermined size. In this case, there is a problem in that the JPEG file cannot be received by the printer and the image data (to-be-printed data) cannot be printed by the printer due to the aforementioned limitations. In addition, in the case where the to-be-printed data are various compressed or non-compressed image data or text data other than the image data of the JPEG file, if the data size exceeds the predetermined size, there is the same problem due to the aforementioned limitations.

In the case where the data size of the file of the to-be-printed data such as a JPEG file transmitted from the information processing apparatus as a host apparatus to the printer exceeds the predetermined size, the data size is reduced so as to solve the aforementioned problem. However, for example, if the data size is reduced by merely increasing a data compression ratio, the result of the printing of the printer is influenced, and in some cases, necessary printing data cannot be obtained, so that the printing may not be normally performed. In addition, in the related art, with respect to the file having such a large data size, a configuration of reducing the data size without great influence on the result of the printing of the printer has not been contrived.

### SUMMARY

An advantage of some aspects of the invention is to provide a technology, where an information processing apparatus as a host apparatus reduces a data size of a file of a to-be-printed data having a data size, which exceeds a predetermined receivable size of a printer, to be equal to or smaller than the predetermined size so that the result of printing of the printer is not greatly influenced and the reduced file is transmitted from the information processing apparatus to the printer so that the to-be-printed data can be printed.

According to an aspect of the invention, there is provided a printer driver (program) which is installed in a computer of an information processing apparatus that transmits a file of to-be-printed data to a printer to allow the computer to function as a determining unit which determines whether or not the data size of the file exceeds the predetermined receivable size of the printer, to function as a reduction condition determining unit which predicts and determines a reduction condition where the data size of the file is equal to or smaller than the predetermined size from a data size reduction operation based on the number of pixels of the file which are extracted within a range where printing is not influenced in the case where the data size of the file exceeds the predetermined size, and to function as a reduction processing unit which reduces the file based on the determined reduction condition, wherein in the case of the reduction condition that the data size of the file is not equal to or smaller than the predetermined size, the reduction condition determining unit determines the reduction condition by further changing a quantization table.

If the printer driver having the configuration according to the invention is installed in the computer of the information processing apparatus, when the file of the to-be-printed data such as a JPEG file is transmitted from the information processing apparatus to the printer, the computer is allowed to function as the determining unit, so that it is determined whether or not the data size of the file exceeds the predetermined receivable size of the printer. If the data size of the file exceeds the predetermined receivable size of the printer, the computer is allowed to function as the reduction condition determining unit, so that the data size reduction operation through the pixel extraction is performed within a range where the printing is not influenced. If the data size of the file still exceeds the predetermined size, the data size reduction operation through the change of the quantization table as well as the pixel extraction is performed so that the data compression ratio is increased. Due to the operation, the reduction condition where the data size of the file is equal to or smaller than the predetermined size is predicted and determined. Next, the computer is allowed to function as the reduction processing unit, so that the data size of the file is reduced so as to be equal to or smaller than the predetermined size based on the determined reduction condition.

In this case, with respect to the file of the to-be-printed data such as a JPEG file of which the data size exceeds the predetermined receivable size of the printer, before the data size is reduced through the quantization table change which greatly influences the result of the printing, the data size of the file is reduced through the pixel extraction within a range where the influence on the printing is weak; and if the data size of the file is not to be smaller than the predetermined size, the data size of the file is reduced so that the data compression ratio is increased through the change of the quantization table. According to the configuration, the data size of the file is reduced so that the result of the printing of the printer is not greatly influenced, and the reduced file is transmitted from the information processing apparatus as a host apparatus to the printer, so that the printing can be performed while greatly suppressing the deterioration in the printing quality of an image or the like of the file.

According to another aspect of the invention, there is provided a printer driver which allows the computer to further function as a re-determining unit which performs determination of the reduction condition of the reduction condition determining unit and the processing of reducing the data size of the file by the reduction processing unit again in an ameliorated condition of the reduction operation so that the data size of the file is included within a suitable size range of which an upper limit is set to the predetermined size in the case where the data size of the file reduced by the reduction processing unit is smaller than the suitable size range.

In a computer of an information processing apparatus, in which the printer driver having the aforementioned configuration according to the invention is installed, when the data size of the file is reduced by the reduction processing unit based on the reduction condition determined by the reduction condition determining unit, if the data size of the file after the reduction is too small so that the data size of the file is smaller than a suitable size range of which the upper limit is set to the predetermined size, in order to prevent the deterioration of the printing quality, the computer is allowed to function as a re-determining unit so that the data size of the file is included within the suitable size range, the reduction condition is re-determined by correcting the data size reduction through the pixel extraction and the data size reduction through the change of the quantization table is corrected in an ameliorated condition, and the data size reduction process for the file is performed again in the re-determined reduction condition. The process is repetitively performed, so that file is reduced to have the data size within a suitable size range without excessive reduction of the file. Therefore, the file which is reduced to have a suitable data size within a suitable size range so as not to further influence the printing of the printer is transmitted from the information processing apparatus to the printer, so that the printing can be performed.

According to another aspect of the invention, there is provided a printer driver, wherein the prediction of the reduction condition of the reduction condition determining unit further includes a sampling condition changing process which changes a color component sampling condition into a predetermined sampling condition which does not influence the printing of the printer in a step before or after the data size reduction operation through the pixel extraction.

In a computer of an information processing apparatus, in which the printer driver having the aforementioned configuration according to the invention is installed, if original to-be-printed data of the file are color image data having an image quality higher than a necessary image quality of the printing of the printer, when the computer is allowed to function as the reduction condition determining unit, the color component sampling condition is changed into a predetermined sampling condition which does not influence the printing of the printer in a step before or after the data size reduction operation through the pixel extraction, so that the reduction condition of the file can be determined so that the data size reduction involving the change of the quantization table may not be performed. In this case, the data size can be reduced while greatly suppressing the change of the quantization table, so that the influence of the reduction of the data size to the printing of the printer can be further decreased.

In addition, in a printer driver according to another aspect of the invention, in the case where the to-be-printed data are image data, since the data size of the file may be easily increased, it is practical and preferable that a file of which the size is reduced and which is transmitted to the printer is a JPEG file.

According to another aspect of the invention, there is provided an information processing apparatus that transmits a file of to-be-printed data to a printer. The information processing apparatus includes: a determining unit which determines whether or not a data size of the file exceeds a predetermined receivable size of the printer; a reduction condition determining unit which predicts and determines a reduction condition where the data size of the file is equal to or smaller than the predetermined size from a data size reduction operation based on the number of pixels of the file which are extracted within a range where printing is not influenced in the case where the data size of the file exceeds the predetermined size; and a reduction processing unit which reduces the file based on the determined reduction condition.

In this case, when the file of the to-be-printed data such as a JPEG file is transmitted from the information processing apparatus to the printer, it is determined by the determining unit whether or not the data size of the file exceeds the predetermined receivable size of the printer. If the data size of the file exceeds the predetermined receivable size of the printer, the data size reduction operation through the pixel extraction is performed by the reduction condition determining unit within a range where the printing is not influenced, so that the reduction condition for the file where the data size is equal to or smaller than the predetermined size is predicted and determined. If the data size of the file still exceeds the predetermined size, the data size reduction condition is predicted and determined through the change of the quantization table as well as the pixel extraction is performed so that the data size of the file is equal to or smaller than the predetermined size. Next, the data size of the file is actually reduced so as to be equal to or smaller than the predetermined size based on the determined reduction condition by the reduction processing unit. Therefore, with respect to the file such as a JPEG file having a data size that exceeds the predetermined receivable size of the printer, the data size of the file is reduced so that the result of the printing of the printer is not greatly influenced, and the file is transmitted from the information processing apparatus to the printer, so that the printing can be performed.

### BRIEF DESCRIPTION OF THE DRAWINGS

The invention will be described with reference to the accompanying drawings, wherein like numbers reference like elements.

FIG. 1 is a block diagram illustrating an embodiment of the invention.

FIG. 2 is a flowchart illustrating some processes of a printer driver of an information processing apparatus of FIG. 1.

FIG. 3 is a flowchart illustrating other processes of the printer driver of the information processing apparatus of FIG. 1.

### DESCRIPTION OF EXEMPLARY EMBODIMENTS

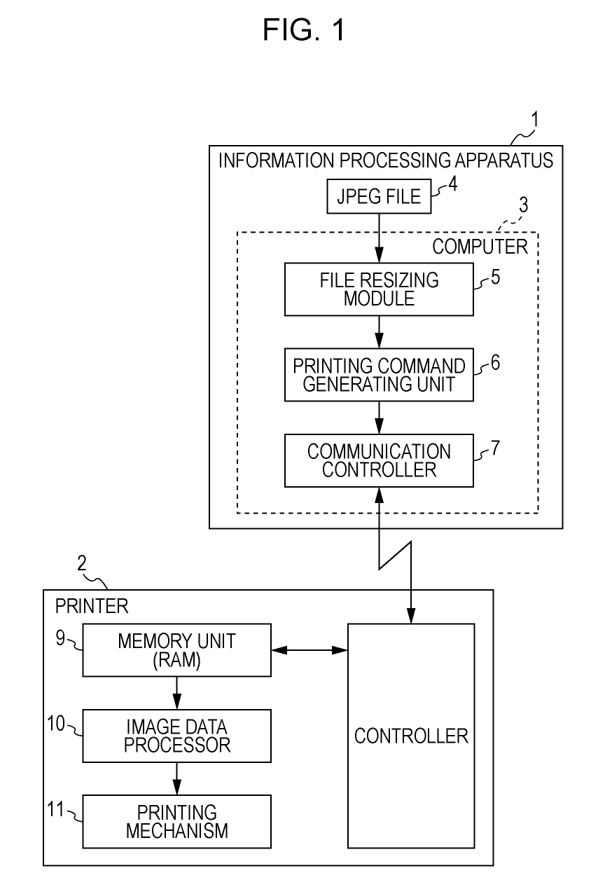

FIG. 1 illustrates an example of a system including an information processing apparatus 1 according to an embodiment of the invention and a printer 2. As a detailed example of the information processing apparatus 1, there are various computer machines (apparatuses) such as a home-use game machine and a PC (personal computer). In addition, an imaging apparatus such as a digital camera may be used for the information processing apparatus 1. As an example of the printer 2, there is a color ink jet printer. In addition, a printer driver (program) for the printer 2 is installed in a computer 3 of the information processing apparatus 1, so that the information processing apparatus 1 is operated as a host apparatus for the printer 2.

To-be-printed data which are to be printed in the information processing apparatus 1, are, for example, color image data of a JPEG file 4 that is obtained by capturing of a digital camera or by downloading from a website. In some cases, data size may exceed a predetermined receivable size (for example, 5 MB or 3 MB) of the printer 2. In addition, in the description hereinafter, the to-be-printed data are referred to as the image data of the JPEG file 4.

In the information processing apparatus 1, a file resizing module 5, a printing command generating unit 6, and a communication controller 7 shown in FIG. 1 are formed by the printer driver.

The printer 2 includes a controller 8 that communicates information with the information processing apparatus 1 to receive the JPEG file 4, a rewritable memory unit 9 such as a RAM that is configured to include a receiving buffer to store the received JPEG file 4, an image data processor 10 that converts the image data of the JPEG file 4 stored in the memory unit 9 into printing data, and a printing mechanism 11 that prints an image of the image data of the JPEG file 4.

In the embodiment, the object of the invention is to reduce the data size of the JPEG file 4 by the file resizing module 5 of the information processing apparatus 1.

Now, the file resizing module 5 is described. The file resizing module 5 allows the computer 3 to functions a determining unit, a reduction condition determining unit, a reduction processing unit, and a re-determining unit according to the invention.

The determining unit checks the predetermined receivable size of the printer 2 through the information communication with the printer 2 and determines whether or not the data size of the JPEG file 4 exceeds the predetermined size.

If the data size of the JPEG file 4 exceeds the predetermined size, the reduction condition determining unit predicts and determines, based on the determination result of the determining unit, a reduction condition that the data size of the JPEG file 4 is equal to or smaller than the predetermined size through a data size reduction operation that is based on the number of pixels of the file, which are extracted within a range where the printing is not influenced, and a data size reduction operation where a quantization table is changed. At this time, the reduction condition determining unit according to the embodiment includes a sampling condition changing process of changing a sampling factor (a color component sampling condition in the invention) into a predetermined sampling factor that does not influence the printing of the printer 2 in a stage before the data size reduction operation for the data where some pixels are extracted. Therefore, if the original image data of the JPEG file 4 are high-image-quality image data which include a large amount of color component data having a higher image quality required for the printing of the printer 2, the reduction condition determining unit changes the sampling factor of the image data into the sampling factor which are minimum data amount that do not influence the printing of the printer 2 before the data size reduction operation for the data where some pixels are extracted. Next, the reduction condition determining unit performs the aforementioned data size reduction operation for the data where some pixels are extracted and the data size reduction operation for the data where the quantization table is changed, so that the file reduction condition is determined. Accordingly, the data size can be reduced so that the change of the quantization table that does greatly influence the printing of the printer 2, that is, the change of the data compression ratio into a high compression ratio is not greatly performed. Therefore, in the case where the JPEG file 4 is transmitted to the printer 2 to be printed, the influence of the reduction can be greatly decreased.

The sampling factor is a ratio of a luminance component Y and red and blue colorimetric components (color components) Cr and Cb of the image data of the JPEG file 4. According to the image quality or the like of the image data, Y:Cr:Cb becomes 4:1:1 (½ extraction), 4:2:2 (⅔ extraction), or the like in the order of largeness of extraction of the colorimetric components Cr and Cb, that is, in the order of smallness of the data size. On the other hand, the printing quality of the printer 2 does not almost deteriorate even in the case of the sampling factor Y:Cr:Cb=4:1:1 having a small data amount. Therefore, in the case where the original sampling factor of the JPEG file 4 is the sampling factor having a large data amount of the colorimetric components Cr and Cb, by the sampling condition changing process of the reduction condition determining unit, the data size for the changed sampling factor Y:Cr:Cb=4:1:1 is calculated.

The reduction operation of the data size through the extraction of the pixels is performed by obtaining a pixel extraction amount from a difference between the number of pixels of the JPEG file 4, of which the sampling factor is equal to or less than Y:Cr:Cb=4:1:1 and the number of printing pixels (the number of pixels required for printing) of the printer 2, which can be obtained through multiplication of a printing resolution (360 [dpi] or 600 [dpi]) of the printer 2 and the number of inches of the horizontal width of the printing sheet, suitably extracting the pixels corresponding to the extraction amount from the decoded image data of the JPEG file 4, and setting each pixel as an average data size per one pixel of the file, thereby calculating the data size in the case where the image data after the extraction are encoded as the JPEG data. Since the data size reduction through the extraction of the pixels has less influence on the printing of the printer 2 than the reduction of the data size reduction through the change of the quantization table, the data size reduction through the extraction is performed before the reduction of the data size prediction through the change of the quantization table.

The reduction operation of the data size prediction through the change of the quantization table is an operation of predicting the data size in the case where the image data, in which the number of printing pixels are extracted, are changed into the quantization table and the data of the JPEG file are re-encoded through the re-quantization having a high compression rate and obtaining the quantization table in which the size is equal to or smaller than the predetermined size (target size). In addition, the change of the quantization table is performed step by step, for example, by subtracting a set value (for example, a unit value such as 5 and 10) from each value of a well-known quantization table of the JPEG file, multiplying predetermined coefficients (for example, coefficients such as 1.1 and 1.2) and each value of the quantization table, or substituting each value of the quantization table for a function of a data size reduction amount.

In the case where the data size of the JPEG file 4 is predicted to be equal to or smaller than the predetermined size by the re-sampling operation, the reduction condition determining unit determines the change of the sampling factor as the reduction condition. In the case where the data size of the JPEG file 4 is predicted to be equal to or smaller than the predetermined size by the reduction operation of the prediction of the data size through the extraction of the pixels, the reduction condition determining unit determines the change of the sampling factor and the extraction of the predicted pixels as the reduction condition. In the case where the data size of the JPEG file 4 is predicted to be equal to or smaller than the predetermined size by the reduction operation of the prediction of the data size through the change of the quantization table, the reduction condition determining unit determines the change of the sampling factor, the extraction of the predicted pixels, and the change of the quantization table as the reduction condition.

The reduction processing unit performs the data size reduction by actually performing changing the sampling factor, extracting pixels, and re-quantization through the change of the quantization table with respect to the JPEG file 4 according to the reduction condition determined by the reduction condition determining unit.

At this time, since the prediction of the reduction of the data size of the JPEG file 4 by the reduction condition determining unit is performed from the average data size per one pixel, the data size of the JPEG file 4, which is actually reduced by the reduction processing unit, may exceed the predetermined size. In this case, since the change of the sampling factor is not further performed, in the state that the number of extracted pixels is increased step by step, and that the condition of the change of the quantization table is changed so that the data compression ratio is decreased step by step, the reduction operation of the prediction of the data size where some pixels are extracted and the reduction operation of the prediction of the data size through the change of the quantization table are repetitively performed until the data size of the JPEG file 4 reduced by the reduction processing unit is equal to or smaller than the predetermined size.

On the other hand, in the case where the data size of the JPEG file 4 which is reduced by the reduction processing unit is much smaller than the predetermined size, in order to prevent the printing quality of the printer 2 to deteriorate, the prediction of the reduction of the data size of the JPEG file 4 by the reduction condition determining unit and the reduction by the reduction processing unit are repetitively performed in an ameliorated condition so that the reduced data size is included within a suitable size range of which the upper limit is the predetermined size by the re-determining unit.

In other words, in the case where the data size of the JPEG file 4, which is reduced according to the determined reduction condition by the reduction processing unit, is smaller than the suitable size range of which the upper limit is set to the predetermined size (for example, 100 to 90% as the predetermined size is set to 100%), the re-determining unit allows the reduction processing unit to perform the reduction operation of the prediction of the data size through the extraction of the pixels and the reduction operation of the prediction of the data size through the quantization table in the ameliorated conditions again so that the data size is included within the suitable size range.

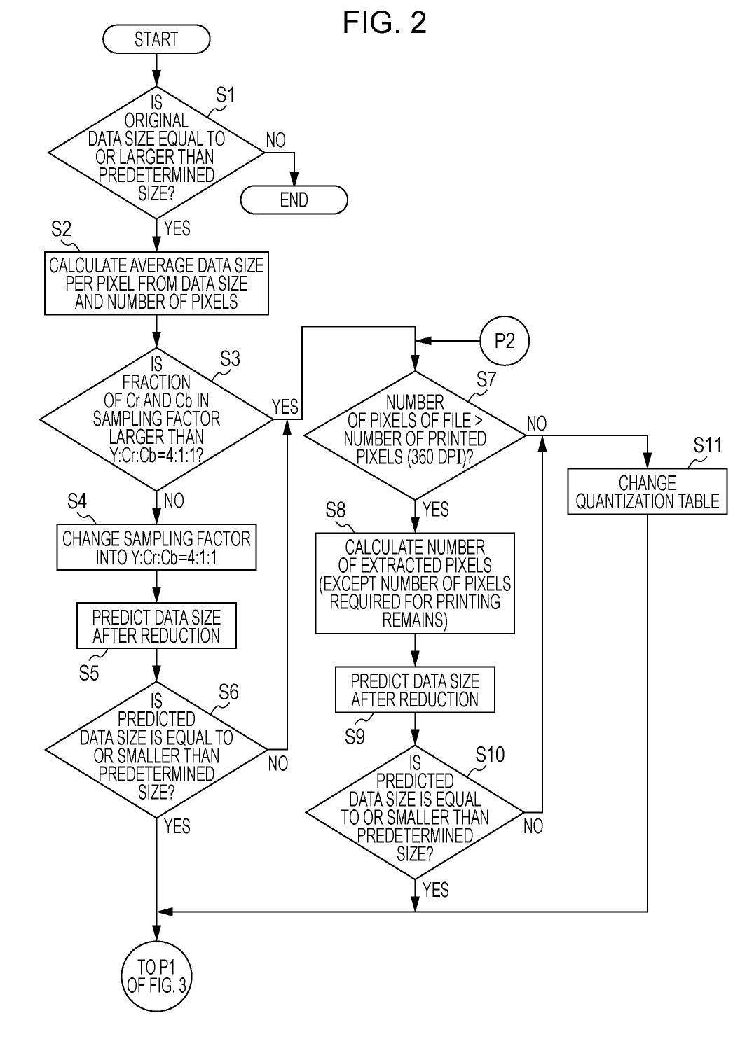

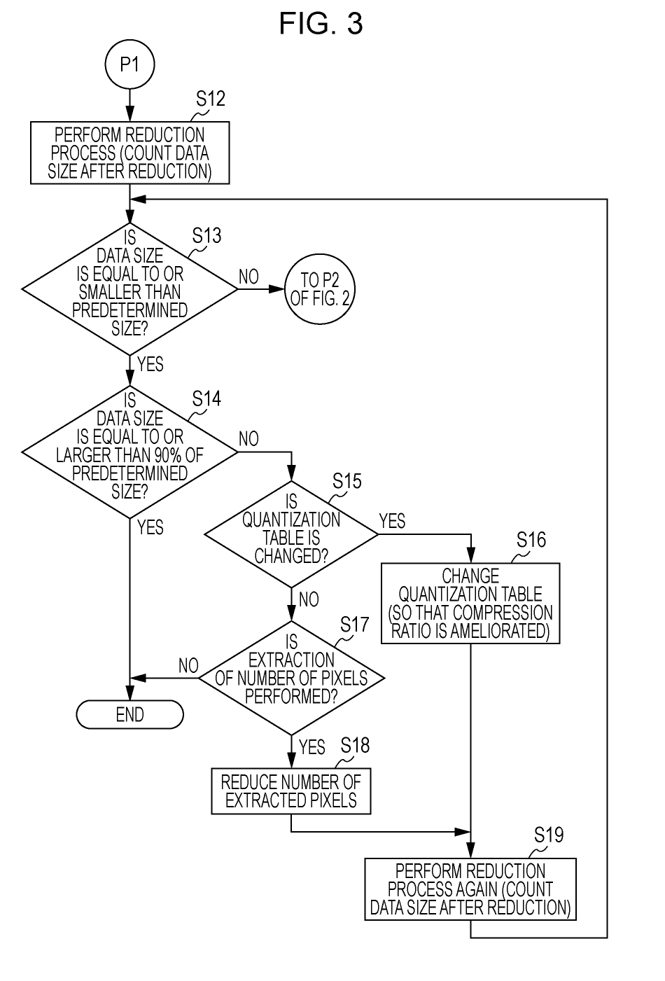

More specifically, the aforementioned data size reduction of the file resizing module 5 is performed according to the procedure of Steps S1 to S19 of FIGS. 2 and 3 described below.

At the time of starting the printing of the JPEG file 4, if the printer 2 notifies file pass, a receivable data size, a printing sheet size, and the like to the information processing apparatus 1, the file resizing module 5 first allows a determining unit to compare an original data size of the JPEG file 4 with a data size of the file received from the printer 2 and to determine whether or not the data size of the JPEG file 4 exceeds the predetermined size (Step S1 of FIG. 2). At this time, if the data size of the JPEG file 4 does not exceed the predetermined size, the JPEG file 4 with the original data size can be transmitted to the printer 2, the result of the Step S1 is negative (NO), so that the process is ended without performing the data size reduction operation. On the other hand, if the original data size of the JPEG file 4 exceeds the predetermined size, the result of the Step S1 is affirmative (YES), the average data size per one pixel is calculated by dividing the data size of the JPEG file 4 by the number of pixels (Step S2 of FIG. 2).

Next, the procedure proceeds from Step S2 to Step S3, it is determined according to the result of the determination of the necessity or un-necessity of the change of the sampling factor in the reduction condition determining unit whether or not the sampling factor of the JPEG file 4 is set to the sampling factor where the data size is larger than Y:Cr:Cb=4:1:1 (Step S3 of FIG. 2). If the sampling factor is set to the sampling factor where the data size is larger than Y:Cr:Cb=4:1:1, the result of Step S3 is YES, so that the sampling factor is changed into Y:Cr:Cb=4:1:1, so that the colorimetric components Cr and Cb are extracted; and the reduced data size of the JPEG file 4 is predicted (Steps S4 and S5 of FIG. 2).

At this time, if the predicted data size is determined to be larger than the predetermined size and if the data size of the JPEG file 4 is determined to exceed the predetermined size by changing the sampling factor into the Y:Cr:Cb=4:1:1, the result of Step S6 of FIG. 2 is NO, so that the aforementioned reduction operation of the prediction of the data size where the pixels are extracted is performed on the JPEG file 4 of which sampling factor is changed into Y:Cr:Cb=4:1:1 in Steps S7, S8, and S9. In other words, with respect to the original JPEG file 4 or the JPEG file 4 of Y:Cr:Cb=4:1:1 after the re-sampling, it is determined whether or not the number of pixels is larger than the number of printing pixels of the printer 2 (Step S7 of FIG. 2). In the case where the number of pixels of the JPEG file 4 is larger than the number of printing pixels of the printer 2 so that the pixel extraction can be performed, the number of extracted pixels is calculated from a difference between the number of pixels of the JPEG file 4 and the number of printing pixels of the printer 2 (Step S8 of FIG. 2). The pixels corresponding to the number of extracted pixels calculated from the image data of the JPEG file 4, and the Y:Cr:Cb=4:1:1 and the data size of the JPEG file 4 which is reduced to the image data having the number of printing pixels of the printer 2 are calculated and predicted (Step S9 of FIG. 2).

In addition, as the result of the pixel extraction, if the data size of the JPEG file 4 after the reduction is predicted to exceed the predetermined size, the procedure proceeds from Step S9 through NO as the result of Step S10 to Step S11, so that the reduction operation of the prediction of the data size is performed so that the data compression ratio is increased by the change of the quantization table. In other words, with respect to Y:Cr:Cb=4:1:1 and the image data where the number of printing pixels of the printer 2 is extracted, the re-quantization is performed, for example, in the state that the data compression ratio is increased step by step, so that the quantization table where the data size is equal to or smaller than the predetermined size is obtained (Step S11 of FIG. 2).

On the other hand, in Step S6, if the data size is predicted to be equal to or smaller than the predetermined size by changing the sampling factor into Y:Cr:Cb=4:1:1, the change of the sampling factor is determined as the reduction condition, so that the result of Step S6 is YES, and the procedure proceeds to Step S12. In addition, in Step S10, if the data size is predicted to be equal to or smaller than the predetermined size by performing the pixel extraction, the pixel extraction is added to the reduction determining condition, and the procedure proceeds to Step S12 of FIG. 3. In addition, in the case where the change of the quantization table from Step S11 is also added to the reduction determining condition, the procedure proceeds to Step S12.

In Step S12 of FIG. 3, the JPEG file 4 is reduced by actually performing the change of the sampling factor, the pixel extraction, and the re-quantization on the image data of the JPEG file 4 based on the reduction condition determined by the reduction condition processing unit, and the number of bytes of the JPEG file 4 after the reduction is counted. Next, the procedure proceeds to Step S13 of FIG. 3. At this time, in general, since the number of bytes of the JPEG file 4 after the reduction is equal to or smaller than the predetermined size, the result of Step S13 is YES, and the procedure proceeds to Step S14 of FIG. 3, and it is determined whether or not the JPEG file 4 after the reduction is smaller than (much smaller than) the suitable size range (Step S15 of FIG. 3).

If the data size of the JPEG file 4 is included within the suitable size range, the result of the Step S14 is YES, so that the data size reduction process is ended. On the other hand, if the data size of the JPEG file 4 is too small, the result of the Step S14 is NO, and thus, the reduction processing unit is allowed to perform the reduction operation of the prediction of the data size through the extraction of the pixels and the reduction operation of the prediction of the data size through the change of the quantization table in the ameliorated conditions again so that the data size is included within the suitable size range. More specifically, it is first determined by Step S15 whether or not the quantization table is changed. If the quantization table is changed, the quantization table is changed into a table of which condition is ameliorated by one step (Step S16 of FIG. 3). If the quantization table is not changed, it is determined whether or not the pixel extraction is performed (Step S17 of FIG. 3). If the pixel extraction is performed, the extraction condition is ameliorated by one step (Step S18 of FIG. 3), and the reduction condition processing unit actually reduces the JPEG file 4 again by performing the pixel extraction and the re-quantization in the ameliorated condition. The number of bytes of the JPEG file 4 after the reduction thereof is counted (Step S19 of FIG. 3), and the procedure returns through Step S13 to Step S14. The operations of Steps S15 to S19 are repetitively performed until the data size of the JPEG file 4 after the reduction thereof is included within the aforementioned suitable size range.

The data size of the JPEG file 4 is reduced by actually performing the change of the sampling factor, the pixel extraction, and the change of the quantization table according to the reduction condition determined by the file resizing module 5 so that the data size is included within the suitable size range. The reduced JPEG file 4 is added with a necessary printing command generated by the printing command generating unit 6, and after that, the JPEG file 4 is transmitted to the printer 2 under a communication control of the communication controller 7 in a wired or wireless manner.

On the other hand, the controller 8 of the printer 2 communicates information with the information processing apparatus 1 to receive the JPEG file 4 and store the JPEG file 4 in the memory unit 9. At this time, since the JPEG file 4 of which original data size exceeds the capacity of the memory unit 9 and is larger than the predetermined receivable size is transmitted with the reduced size that is equal to or smaller than the predetermined size, the transmitted JPEG file 4 is surely received by the printer 2 to be stored in the memory unit 9.

The image data of the JPEG file 4 stored in the memory unit 9 are converted into the printing data according to a received printing command by the image data processor 10. Due to the control of moving of the ink head and feeding and discharging of the sheet by the printing mechanism 11, ink is sprayed from each color nozzle of the ink head on the sheet according to the printing data, so that an image of the image data of the JPEG file 4 is printed on the sheet in a well-known ink jet manner. At this time, since the JPEG file 4 stored in the memory unit 9 is reduced by suitably performing the change of the sampling factor, the pixel extraction, and the change of the quantization table so that the printing is not greatly influenced, the deterioration in the image quality of the printed image caused by the data size reduction is suppressed to the minimum.

As described above, in the embodiment, when the JPEG file 4 of the image data that are the to-be-printed data is transmitted from the information processing apparatus 1 as a host apparatus to the printer 2, by the printer driver installed in the information processing apparatus 1, the computer 3 of the information processing apparatus 1 is allowed to function as a determining unit, a reduction condition determining unit, and a reduction processing unit. In the case where the data size of the JPEG file 4 exceeds the predetermined receivable size of the printer 2, the data size reduction through the pixel extraction is firstly performed, and the pixel extraction and the data size reduction through the change of the quantization table are predicted. Next, the reduction condition where the printing of the printer 2 is weakly influenced is determined from the prediction. The JPEG file 4 is reduced to have a size equal to or smaller than the predetermined size based on the determined reduction condition so that the result of the printing is not greatly influenced. Accordingly, the reduced JPEG file 4 is transmitted from the information processing apparatus 1 to the printer 2, so that the image where deterioration in the printing quality is greatly suppressed can be printed by the printer 2.

Therefore, there may be provided a printer driver that is not disclosed in the related art and an information processing apparatus 1 including a computer 3 in which the printer driver is installed, wherein when a file of the to-be-printed data is transmitted from the information processing apparatus 1 as a host apparatus to the printer 2, the file of the to-be-printed data having a data size that exceeds the predetermined receivable size of the printer 2 is reduced to have a data size that is equal to or smaller than the predetermined size so that the result of the printing of the printer 2 is not greatly influenced, and the reduced file is transmitted from the information processing apparatus 1 to the printer 2, so that the to-be-printed data can be printed.

In addition, when the data size after compression is too small due to the pixel extraction and the change of the quantization table, the computer 3 of the information processing apparatus 1 is allowed to function as a re-determining unit. The reduction condition according to the pixel extraction and the change of the quantization table is determined again in an ameliorated condition so that the data size after the compression is included within a suitable size range, and the process of reducing the data size of the JPEG file 4 is performed according to the re-determined reduction condition. Therefore, the JPEG file 4 is reduced to be included within the suitable size range that is equal to or smaller than the predetermined size so that the size is not excessively reduced. The reduced JPEG file 4 is transmitted to the printer 2, so that the printing thereof can be performed.

In addition, before the reduction operation for the data size for the data where some pixels are extracted is performed, the sampling factor is changed into a predetermined sampling factor that does not influence the printing of the printer 2. Since the file reduction condition can be determined so that the data size reduction involving the change of the quantization table is not greatly performed, the data size of the file of the image data including color components having higher image quality than the image quality required for the printing of the printer 2 can be particularly reduced while greatly suppressing the influence of the high data compression ratio involved with the change of the quantization table.

In addition, the invention is not limited to the aforementioned embodiments, but various modifications can be made without departing from the spirit of the invention. For example, the sampling factor changing process may be performed after the prediction operation through the pixel extraction. In addition, in the case where the sampling factor of the JPEG file 4 is always Y:Cr:Cb=4:1:1, the process sampling condition changing process may be omitted. In addition, for simplifying the processes, the re-determining unit may be omitted.

In addition, the predetermined size, the suitable size range, and the number of printing pixels may be suitably set according to specifications of the printer 2. In addition, the to-be-printed data are not limited to the image data, but the to-be-printed data may be text data or the like. In addition, the file of the to-be-printed data is not limited to the JPEG file 4, but the file may be various types of compressed or non-compressed data files.

In addition, the information processing apparatus 1 may be various types of computer apparatuses (machines). The printer 2 is not limited to the ink jet printer, but the printer may be various printing type printers.

What is claimed is:

1. An information processing apparatus which transmits a file of to-be-printed data to a printer to perform printing, comprising:
a determining unit which determines whether or not a data size of the file exceeds a predetermined receivable size of the printer;
a reduction condition determining unit which predicts and determines a reduction condition where the data size of the file is equal to or smaller than the predetermined size from a data size reduction operation based on the number of pixels of the file which are extracted within a range where printing is not influenced in the case where the data size of the file exceeds the predetermined size and which determines the reduction condition by further changing a quantization table in the case where the data size of the file is not equal to or smaller than the predetermined size;
a reduction processing unit which reduces the data size of the file based on the determined reduction condition; and
a re-determining unit which performs determination of the reduction condition of the reduction condition determining unit and the processing of reducing the data size of the file by the reduction processing unit again in an ameliorated condition of the reduction operation so that the data size of the file is included within a suitable size range of which an upper limit is set to the predetermined size in the case where the data size of the file reduced by the reduction processing unit is smaller than the suitable size range.

2. The information processing apparatus according to claim 1, wherein the prediction of the reduction condition of the reduction condition determining unit further comprises a sampling condition changing process which changes a color component sampling condition into a predetermined sampling condition in a step before or after the data size reduction operation through the pixel extraction.

3. The information processing apparatus according to claim 1, wherein the file is a JPEG file.
